(19) United States
(12) Patent Application Publication
(10) Pub. No.: US 2026/0351542 A1
(43) Pub. Date: Nov. 5, 2026

(54) GAS DELIVERY AND PURIFICATION SYSTEM FOR CONTINUOUS MONITORING IN MASS SPECTROMETRY

(71) Applicant: The Regents of the University of California, Oakland, CA (US)

(72) Inventors: Benjamin Birner, San Diego, CA (US); Ralph Keeling, San Diego, CA (US); Eric Morgan, San Diego, CA (US)

(21) Appl. No.: 19/099,252

(22) PCT Filed: Jul. 28, 2023
(86) PCT No.: PCT/US2023/071257

§ 371 Date: Jan. 28, 2025

Related U.S. Application Data
(60) Provisional application No. 63/393,478, filed on Jul. 29, 2022.

(51) Int. Cl. H01J 49/04; B01D 8/00

(52) U.S. Cl. CPC H01J 49/0422; B01D 8/00; H01J 49/0468

(57) ABSTRACT

Systems and methods are provided for a gas delivery and purification system for continuous monitoring in mass spectrometry. A system includes a purification system configured to cryogenically purify a sample gas and a reference gas for analysis by a mass spectrometer. The system may also include a control system including a controller configured to: modulate a first valve to alternate flow between the sample gas and the reference gas into the purification system, operate the purification system to separately cryogenically purify the sample gas and the reference gas, and modulate a second valve to stabilize a pressure of the sample gas and the reference gas during operation of the purification system and to alternate delivery of the purified sample gas and the purified reference gas under constant flow to the mass spectrometer. Related methods and articles of manufacture are also disclosed.

### CROSS-REFERENCE TO RELATED APPLICATIONS

The present application claims priority to U.S. Provisional Application No. 63/393,478, filed Jul. 29, 2022, and entitled “Gas Delivery and Purification System for Continuous Monitoring of Atmospheric Helium and Other Trace Gases,” the entirety of which is incorporated by reference herein.

### STATEMENT OF GOVERNMENT SUPPORT

This invention was made with government support under AGS-1940361 awarded by the National Science Foundation. The government has certain rights in the invention.

### FIELD

The subject matter described herein relates generally to mass spectrometry, and more specifically to a gas delivery and purification system for continuous monitoring in mass spectrometry.

### BACKGROUND

Mass spectrometry is an analytical technique that is used to measure the mass-to-charge ratio of ions, among other aspects of gases. Mass spectrometers for high precision gas analysis may compare concentrations of elements within an unknown sample gas and a known standard or reference gas. Repeated comparisons of the two gases flowing into the mass spectrometer allow determination of differences in the gas composition. However, concentrations of non-target elements within the gases can bias measurements and/or cause the comparisons to become increasingly inaccurate.

### SUMMARY

In some variations, a system is provided. The system includes a purification system configured to cryogenically purify a sample gas and a reference gas for analysis by a mass spectrometer. The system may also include a control system coupled to the purification system. The control system includes a controller configured to: modulate a first valve to alternate flow between the sample gas and the reference gas into the purification system, operate the purification system to separately cryogenically purify the sample gas and the reference gas, and modulate a second valve to stabilize a pressure of the sample gas and the reference gas during operation of the purification system and to alternate delivery of the purified sample gas and the purified reference gas under constant flow to the mass spectrometer.

In some variations, the controller is configured to operate the purification system to purify the sample gas and the reference gas by at least isolating a target portion of the sample gas and the reference gas for analysis by the mass spectrometer. The controller is further configured to operate the purification system to purge a remaining portion of the sample gas and the reference gas.

In some variations, the target portion includes at least one of helium, nitrogen, and neon.

In some variations, the purification system includes a first cold trap in which the sample gas is configured to be purified by at least reducing a temperature of the sample gas to isolate a target portion of the sample gas, and a second cold trap configured to be regenerated for removal of a remaining portion of the reference gas from the second cold trap while the sample gas is purified within the first cold trap. The remaining portion of the reference gas remained within second cold trap after purification of the reference gas within the second cold trap. The first cold trap and the second cold trap allows for continuous purification and monitoring of the sample gas and/or the reference gas within the purification system.

In some variations, the controller is configured to modulate at least the first valve to cause flow of the sample gas or the reference gas to the first cold trap or the second cold trap.

In some variations, the controller is configured to continuously monitor the sample gas and/or the reference gas within the first cold trap and the second cold trap.

In some variations, the second cold trap comprises a heater, and the controller is configured to operate the heater to regenerate the second cold trap for removal of the remaining portion of the reference gas by at least heating the remaining portion.

In some variations, the sample gas is a first mixture and the reference gas is a second mixture. Purification of the sample gas and the reference gas isolates a target portion of the first mixture and the second mixture for analysis by the mass spectrometer.

In some variations, the first valve comprises at least one valve and the second valve comprises at least one valve.

In some variations, the controller is configured to module the first valve and the second valve to maintain the constant flow of the sample gas and the reference gas to the mass spectrometer.

According to some variations, a method includes modulating a first valve to alternate flow between the sample gas and the reference gas into a purification system configured to cryogenically purify a sample gas and a reference gas for analysis by a mass spectrometer. The method may also include operating the purification system to separately cryogenically purify the sample gas and the reference gas. The method may also include modulating a second valve to stabilize a pressure of the sample gas and the reference gas during operation of the purification system and to alternate delivery of the purified sample gas and the purified reference gas under constant flow to the mass spectrometer.

In some variations, the operating includes isolating a target portion of the sample gas and the reference gas for analysis by the mass spectrometer, and purging a remaining portion of the sample gas and the reference gas.

In some variations, the target portion includes at least one of helium, nitrogen, and neon.

In some variations, the purification system includes a first cold trap in which the sample gas is configured to be purified by at least reducing a temperature of the sample gas to isolate a target portion of the sample gas, and a second cold trap configured to be regenerated for removal of a remaining portion of the reference gas while the sample gas is purified within the first cold trap. The remaining portion of the reference gas remained within second cold trap after purification of the reference gas within the second cold trap. The first cold trap and the second cold trap allows for continuous purification and monitoring of the sample gas and/or the reference gas within the purification system.

In some variations, the method includes modulating at least the first valve to cause flow of the sample gas or the reference gas to the first cold trap or the second cold trap.

In some variations, the method includes continuously monitor the sample gas and/or the reference gas within the first cold trap and the second cold trap.

In some variations, the method includes the second cold trap includes a heater, and the method further includes operating the heater to regenerate the second cold trap for removal of the remaining portion of the reference gas by at least heating the remaining portion.

In some variations, the method includes the sample gas is a first mixture, and the reference gas is a second mixture. Purification of the sample gas and the reference gas isolates a target portion of the first mixture and the second mixture for analysis by the mass spectrometer.

In some variations, the method includes the first valve includes at least one valve, and the second valve includes at least one valve.

In some variations, the method includes modulating the first valve and the second valve to maintain the constant flow of the sample gas and the reference gas to the mass spectrometer.

According to some variations, a non-transitory computer-readable medium storing instructions, which when executed by at least one data processor, result in operations including modulating a first valve to alternate flow between the sample gas and the reference gas into a purification system configured to cryogenically purify a sample gas and a reference gas for analysis by a mass spectrometer. The operations also include operating the purification system to separately cryogenically purify the sample gas and the reference gas. The operations also include modulating a second valve to stabilize a pressure of the sample gas and the reference gas during operation of the purification system and to alternate delivery of the purified sample gas and the purified reference gas under constant flow to the mass spectrometer.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a block diagram illustrating a mass spectrometer system, in accordance with some example implementations;

FIG. 2A depicts an example purification system for a mass spectrometer system, in accordance with some example implementations;

FIG. 2B depicts an example purification system for a mass spectrometer system with a purification system, in accordance with some example implementations;

FIG. 2C depicts an example purification system for a mass spectrometer system with a purification system, in accordance with some example implementations;

FIG. 3A depicts an example graph showing testing results, in accordance with some example implementations;

FIG. 3B depicts an example graph showing testing results, in accordance with some example implementations;

FIG. 4 depicts a flowchart illustrating a process for increasing the precision of a mass spectrometer in analyzing a gas, in accordance with some example implementations; and

FIG. 5 depicts a block diagram illustrating a computing system, in accordance with some example implementations.

When practical, similar reference numbers denote similar structures, features, or elements.

### DETAILED DESCRIPTION

Generally mixtures (e.g., gases) analyzed by mass spectrometers can contain a number of elements including target species of interest and other non-target species that may not be relevant to the analysis. When mass spectrometers analyze such mixtures, the results can be imprecise due to the presence of the non-target species.

This can be problematic in various applications, such as when determining changes in atmospheric concentrations of certain elements, such as helium, contamination levels in various gaseous mixtures, etc., where precise measurements are important for accurately detecting harmful concentrations. As an example, rising atmospheric levels of helium are a result of the increasing use of natural gas on a global scale. Helium is co-released to the atmosphere during natural gas extraction, purification, and usage because 4-helium (4He), the more abundant isotope of helium, accumulates in the same geological reservoirs after it is produced by radioactive decay of uranium and thorium-baring minerals. Since other fossil fuels are thought to contain much less helium, helium may prove to be a valuable conservative tracer for the consumption of natural gas, which could aid efforts to quantify global emissions with top-down techniques.

In some methods for detecting changes in atmospheric element concentrations, such as helium concentrations, changes in the dry air mole fraction (e.g., in an example of helium, He/M) were observed by precisely stabilizing the flow of an air sample and an air-like reference gas to a mass spectrometer, which constantly monitored the ion beam of interest (e.g., 4He+). By maintaining constant flow of air to the mass spectrometer between the sample and reference gases, changes in the ion beam of interest reflected mole fraction differences between the sample and reference gases. However, such conventional methods generally relied on large air samples, substantial analysis time and computing resources, and frequent replacement of the chemical purification reagents used for treating the air prior to the air entering the mass spectrometer.

The mass spectrometer system described herein enables the semi-continuous or continuous observation of target species (e.g., atmospheric helium) concentration levels with a high level of precision. The mass spectrometer system does so by at least enriching the concentration of the target species in the gas stream using a cryogenic purification method. This method allows for automated and continuous operation of a purification system that purifies the reference and sample gases prior to delivering the reference and sample gases to the mass spectrometer for analysis. As described herein, the purification system may cryogenically purify the reference and sample gases before delivering the gases to the mass spectrometer. The purification system may include two cold traps that allows for continuous purification and monitoring of the gases by at least implementing one cold trap to purify a gas (e.g., to increase the concentration of a target species) while the other cold trap regenerates to remove a remaining portion of the gas (e.g., to heat and purge the non-target species). For example, the cold trap may heat to release the remaining portion of the gas (which was accumulated during the previous use) to waste. This regeneration cycle is used to clear out the remaining portion of the stored gas to prepare the cold trap for purification. Accordingly, the mass spectrometer system described herein purifies the reference and sample gases under steady flow and with stabilized pressures, improving the precision of mass spectrometer analysis and monitoring of the gases.

Further, several studies have demonstrated that earthquakes are associated with helium anomalies in soil, air, and ground water which can precede seismic events by up to several weeks. This suggests that continuous monitoring of helium has the potential to become a powerful tool for predicting earthquakes. The mechanism for the early helium signal is unknown but may be linked to deformation of rocks and compression causing migration of fluids before an earthquake which could modulate how helium is released. Conventional methods have been unable to provide real time data and may have missed important transient signals as such methods depended on the collection of discrete field samples for later analysis in a laboratory. In contrast, the mass spectrometer system described herein can be deployed in the field and continuously monitor helium levels in a suitable gas stream, such as gasses stripped from deep-pumped ground water wells or hydrothermal sources, and become part of an earthquake early warning system.

Consistent with implementations of the current subject matter, the mass spectrometer system may include a control system including a controller for controlling operation of one or more aspects of the mass spectrometer system. The controller may modulate a first valve (e.g., at least one valve, a flow control device, etc.) to alternate flow between a sample gas and a reference gas into a purification system. The controller may operate the purification system to separately purify the sample gas and the reference gas. Further, the controller may modulate a second valve (e.g., at least one valve, a flow control device, etc.) to stabilize the pressure of the sample gas and the reference gas during operation of the purification system and to alternate delivery of the purified sample gas and the purified reference gas under constant flow to the mass spectrometer. This improves the accuracy, consistency, and reliability of the measurements during testing of the gases using the mass spectrometer. Further, differences in gas species ion beam intensities between sample and standard gases measured by the mass spectrometer system described herein reflect differences in the mole fraction of those gases. This allows for building a time series of changes in the mole fraction of many different gases, including noble gases and others, that are tested by the mass spectrometer.

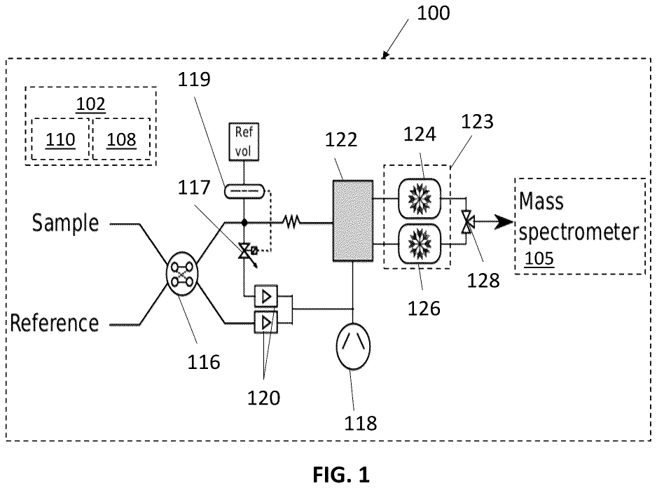

FIG. 1 depicts a block diagram illustrating a mass spectrometer system 100, consistent with implementations of the current subject matter. The mass spectrometer system 100 includes a control system 102, a purification system 123, and/or a mass spectrometer 105. The control system 102 controls (e.g., continuously) at least one (e.g., a plurality) valve, such as dynamic or static valves, to stabilize a pressure of the gases passing through the mass spectrometer system 100, to provide constant or steady flow of the gases through the mass spectrometer system 100 to the mass spectrometer 105, to provide constant monitoring of the gases through the mass spectrometer system 100, and/or the like.

The mass spectrometer 105 may include any type of mass spectrometer. During testing, the mass spectrometer 105 may rapidly alternate supplying continuous streams of a sample gas and a reference gas so that a number of comparison measurements, including isotope ratios, ion mass-to-charge ratios, mole fractions of target species within the gases, among others, may be collected for both gases. The mass spectrometer 105 may include an ion counter and/or an array of Faraday cups (e.g., conductive, metal vessels which neutralize ions that hit them while becoming charged), which allows the simultaneous detection of multiple isotopes, among other configurations.

Further, as described herein, the mass spectrometer 105 provides measurements with improved precision due at least to the configurations of the current subject matter. In other words, the mass spectrometer 100, such as via the control system 102 including the controller 110, purify the sample and reference gases and provide the sample and reference gases to the mass spectrometer 105 under steady or constant flow and/or under stable pressures. Additionally and/or alternatively, the purification system 123 purifies the gases by at least increasing the concentration of the target species (e.g., elements such as certain noble gases of interest) within the gases before delivering the purified gases to the mass spectrometer 105. As a result, the mass spectrometer 105 differences in gas species ion beam intensities between the sample gas and reference gas detected by the mass spectrometer 105 reflect differences in the mole fraction of those gases. This allows for the mass spectrometer system 100 to build a time series of changes in the mole fraction of many different gases, including noble gases and others, that are tested by the mass spectrometer 105.

Additionally and/or alternatively, the configurations of the mass spectrometer system 100 described herein allow for the mass spectrometer 105 to use a single ion beam to make precise mole fraction measurements. Such systems consistent with implementations of the current subject matter can be used for environmental monitoring applications. For example, when measuring concentrations of helium, which is commonly found in natural gas, the mass spectrometer 105 could be used to detect small changes in atmospheric helium content, which could be used for the detection of leaks or monitor pollution levels, among other applications.

As described herein, a sample gas may include a gas, such as a gas mixture of unknown composition, being analyzed by the mass spectrometer 105. The sample gas may be composed of air and/or include one or more noble gases or other gases (e.g., carbon, nitrogen, hydrogen, helium, neon, etc.). Sample gases may be introduced as pure gases, achieved through combustion, gas chromatographic feeds, chemical trapping, and/or the like. A reference gas may include a gas mixture with known composition that is used as a reference by the mass spectrometer 105 for comparison with the sample gas. The mass spectrometer 105 may accurately measure the mole fraction of specific target portions (e.g., species of interest with the gas mixture) to characterize the abundance of the target species in the sample gas mixture .. The results of the testing by the mass spectrometer 105 may be provided, such as via a display (not shown) coupled to the mass spectrometer system 100. For example, the results, including a mass spectrum, a plot of intensity, and/or other determined data or measurements, may be provided via the display.

Referring back to FIG. 1, the control system 102 may include a controller 110 and a data acquisition device 108, which may include or be coupled to a controller 110. The data acquisition device 108 and/or the controller 110 may include at least one data processor and at least one memory for storing instructions configured to be executed by the at least one data processor to perform one or more operations described herein. The controller 110 may be a proportional-integral-derivative (“PID”) controller. For example, the controller 110 may be a feedback or control loop mechanism that employs feedback, such as an input to maintain a constant pressure and/or steady or constant flow of the gases within the mass spectrometer system 100. For example, the data acquisition device 108 may receive as an input a measured internal pressure or flow rate of the gases through the purification system 123, such as from a pressure gauge, one or more flow meters (e.g., flow meters 120 shown in FIG. 1), and/or the like. The controller 110 may maintain the constant flow and/or monitoring of the gases based at least on the received input.

The control system 102 may additionally and/or alternatively include one or more valves that are controlled by the controller 110. The one or more valves may include one or more flow control devices, shut-off valves, three-way valves, a changeover valve, a static flow restriction, and/or the like. The controller 110 may modulate the one or more valves to maintain the constant pressure and/or flow within at least the purification system 123, allowing for constant monitoring of the gases and improving the precision of the mass spectrometer 105.

As described in more detail herein, the one or more valves may include a first valve 116, a second valve 128, a proportional solenoid valve 117, a valve block 122, and/or the like. The first valve 116 may be a change-over-valve (COV), a two-way valve, a three-way valve, a pneumatic valve, a shut-off valve, an adjustable-flow valve, or other configuration. The second valve 128 may be a COV valve, two-way valve, a three-way valve, a pneumatic valve, a shut-off valve, an adjustable-flow valve, or other configuration. The valve block 122 may include at least one valve, such as a trap selector valve and/or a purge valve. The trap selector valve and/or the purge valve may be a two-way valve, a three-way valve, a pneumatic valve, a shut-off valve, an adjustable-flow valve, or other configuration, and may be coupled to the purification system 123. As described in more detail herein, the valve block 122 allows for switching between sample and reference gas and directing the sample and reference gases to cold traps 124, 126. The valve block 122 also allows for the regeneration of the cold traps 124, 126, since the valve block 122 can open one of the cold traps to the vacuum pump 118 while the other cold trap is delivers purified gas to the mass spectrometer 105.

The first valve 116 may be modulated (e.g., by the controller 110) to switch between the two sources of gas (e.g., the sample gas and the reference gas) with active pressure stabilization to remove flow perturbation. The controller 110 may modulate the first valve 116 to alternate flow of the sample gas and the reference gas into the purification system 123. The controller 110 may modulate the first valve 116 at predefined intervals (e.g., 1 second, 5 seconds, 10 seconds, 30 seconds, etc.). In other words, the controller 110 may modulate the first valve 116 at the predefined intervals to alternate allowing flow of the reference gas into the purification system 123 and allowing flow of the sample gas into the purification system 123. In some embodiments, the first valve 116 provides pressure stabilization to the gases delivered to the purification system 123.

While the reference gas and the sample gas are alternated, the reference gas and the sample gas may flow along the same flow path from the inlet of the mass spectrometer system 100 to the mass spectrometer 105. The reference gas and/or the sample gas may flow from the first valve 116 to the purification system 123. Along the flow path between the first valve 116 and the purification system 123, at least a portion of the reference gas and/or the sample gas may pass flow meters 120. The flow meters 120 may include one, two, three, or more flow meters. The flow meters 120 may monitor a pressure and/or flow rate of the reference gas and/or sample gas passing the flow meters 120. The flow meters 120 can be used to monitor the gas stream and adjust the upstream valves (e.g., the first valve 116). For example, the measurements may be transmitted from the flow meters 120 to the data acquisition device 108.

The controller 110 may, based at least on the measurements, adjust one or more valves upstream of the flow meters 120 to allow more or less gas through the valves to maintain a predetermined flow rate, pressure, and/or the like. As an example, the mass spectrometer system 100 (e.g., the control system 102) may also include a differential pressure transducer 119. The differential pressure transducer 119 and/or the proportional solenoid valve 117 (which may include one, two, or more valves, such as flow control valves) may further be modulated by the controller 110 to help maintain a constant pressure and/or flow of the gases along the flow path. Thus, the controller 110 helps to ensure that the appropriate amount of gas (e.g., sample gas or reference gas) is purified and analyzed by the mass spectrometer. Additionally and/or alternatively, this helps to stabilize the pressure and/or maintain constant flow of the gases along the flow path, further improving precision of the mass spectrometer 105.

Again referring to FIG. 1, the purification system 123 may purify the sample gas and the reference gas prior to delivering the sample gas and the reference gas to the mass spectrometer 105 for analysis. The controller 110 may separately operate the purification system 123 to separately purify the sample gas and the reference gas. The purification system 123 enriches the gas (e.g., sample gas, reference gas, etc.) being purified by at least increasing the concentration of or isolating a target portion (e.g., a target species or element) of the gas for analysis by the mass spectrometer 105. Consistent with implementations of the current subject matter, the purification system 123 enriches the gas while the gas is under constant flow.

Increasing the concentration of the target portion and/or isolating the target portion within the gas improves precision of the mass spectrometer 105 during analysis of the gas. In some embodiments, the target portion includes at least one gas, such as helium, nitrogen, and/or neon. Further, as described herein, the purification system 123 may purge the remaining portion of the gas (e.g., sample gas, reference gas, etc.) resulting in the remaining portion of the gas not being analyzed by the mass spectrometer 105. The remaining portion can include non-target species, contaminants, and/or the like that are not of interest for analysis.

As an example, the purification system 123 may be a cryogenic gas purification system 123 configured to cryogenically purify the sample gas and the reference gas. The purification system 123 may additionally and/or alternatively be another type of purification system that enriches the gas (e.g., sample gas, reference gas, etc.) consistent with implementations of the current subject matter. The cryogenic gas purification system 123 may generally reduce a temperature of the gas (e.g., the sample gas, reference gas, etc.) to freeze the non-target species within the gas, while isolating and/or increasing the concentration of the target species within the gas.

The purification system 123, such as when the purification system is a cryogenic gas purification system, may include at least two cold traps (e.g., a first cold trap 124, a second cold trap 126, and so on). Either of the sample gas and the reference gas may be purified in each of the cold traps. Generally, one of the gases (e.g., the sample gas or the reference gas) may be purified in one of the cold traps while the other cold trap is regenerated to remove the gas contained within the other cold trap. As an example, the sample gas may first be purified in the first cold trap 124. In this example, the sample gas is purified in the first cold trap 124 by reducing a temperature of the sample gas by freezing the gas, adding ice or another frozen media to the first cold trap 124, and/or the like, to increase the concentration of or isolate the target portion of the sample gas for analysis by the mass spectrometer 105.

After the sample gas has been purified within the first cold trap 124 and at least the target portion of the sample gas has been delivered to the mass spectrometer 105, the first cold trap 124 is regenerated to remove the remaining portion of the sample gas within the first cold trap 124. For example, the first cold trap 124 and/or the second cold trap 126 may include a heater. The controller 110 may operate the heater to regenerate the first cold trap 124 and/or the second cold trap 126 to remove the remaining portion of the sample gas by heating the remaining portion of the sample gas. Doing so may change a state of the remaining portion and/or change a property of the remaining portion of the sample gas. This allows for the remaining portion of the sample gas to be purged from the purification system 123 since it is not needed for analysis by the mass spectrometer 105.

Concurrently (or with at least some overlap in time), the reference gas may be purified within the second cold trap 126 using the same methods described herein for purifying the sample gas. Later, the cold trap containing the remaining portion of the reference gas and/or the sample gas may be regenerated within the second cold trap 126 while another portion of the sample gas is purified within the first cold trap 124.

For example, a cold trap may be regenerated at an interval (e.g., approximately every 90 minutes), and at the same time, sample and reference gases can be alternatively purified within the other cold trap. In other words, the heating of the trap regenerates the trap. When the gas is purified, the remaining portion of the gas is frozen or condensed within the cold trap, while the target portion is delivered to the mass spectrometer 105. After the cold trap fills (e.g., to a threshold level) with the frozen gas, the cold trap is heated, which liberates the frozen gas for the remaining portion of the gas to be discarded. At the same time, the other cold trap can be used for purification of the reference gas and/or the sample gas (e.g., alternated between purifying the reference and sample gases).

The configurations described herein allow for at least one gas (e.g., the sample gas or the reference gas) to be purified in one of the cold traps while the other cold trap is regenerated, providing constant flow of the gases through the mass spectrometer system 100 and allowing for continuous monitoring of the gases as they are purified and/or regenerated. This also reduces the amount of time needed for purification and/or analysis of the gases since one gas can be purified within one of the cold traps while the other gas is being purged from the other cold trap.

Referring to FIG. 1, the valve block 122 may be coupled to and/or form a part of the purification system 123. The valve block 122 may include a trap selector valve and/or a purge valve. The valve block 122 may additionally and/or alternatively include a three-way valve or another type of valve. The valve block 122 may be modulated by the controller 110 to alternate flow of the sample gas and/or the reference gas into one of the cold traps for purification and (in some embodiments, at the same time) to evacuate the remaining portion of the purified gas from the other cold trap during or after regeneration of the cold trap containing the remaining portion of the gas.

The cold traps (e.g., the first cold trap 124, the second cold trap 126, etc.) can be designed to improve purification and/or regeneration efficiency and speed, while improving precision of the mass spectrometer 105. For example, a larger cold trap can contain more frozen gas (e.g., the remaining portion or non-target species of the gas) before blocking the gas flow and thus allows for longer operation periods before regeneration and evacuation of the remaining portion. Larger cold traps may also provide higher gas flow and thus ion beam intensities, yielding better precision. On the other hand, smaller cold traps may take less time to flush out completely, but would need to be evacuated at higher frequencies. Thus, the size of the cold trap can be specifically selected to allow for constant flow and monitoring of the gases.

To further reduce the time of the gases within each of the cold traps while increasing trapping capacity, the cold traps may be positioned closer to the mass spectrometer 105 and further increases conductance between the cold traps and the mass spectrometer 105. Using tubing (e.g., 0.25 inch tubing, etc.) that matches the tubing size of the mass spectrometer 105 may allow for faster switching between sample and reference gases, which removes more drift from the analyzer while allowing more gas (e.g., the sample gas and/or the reference gas) to be delivered to the mass spectrometer 105, yielding further precision improvements. The higher volume tubing increases the total lifetime of the cold trap (i.e., how long the cold trap can go between regenerations).

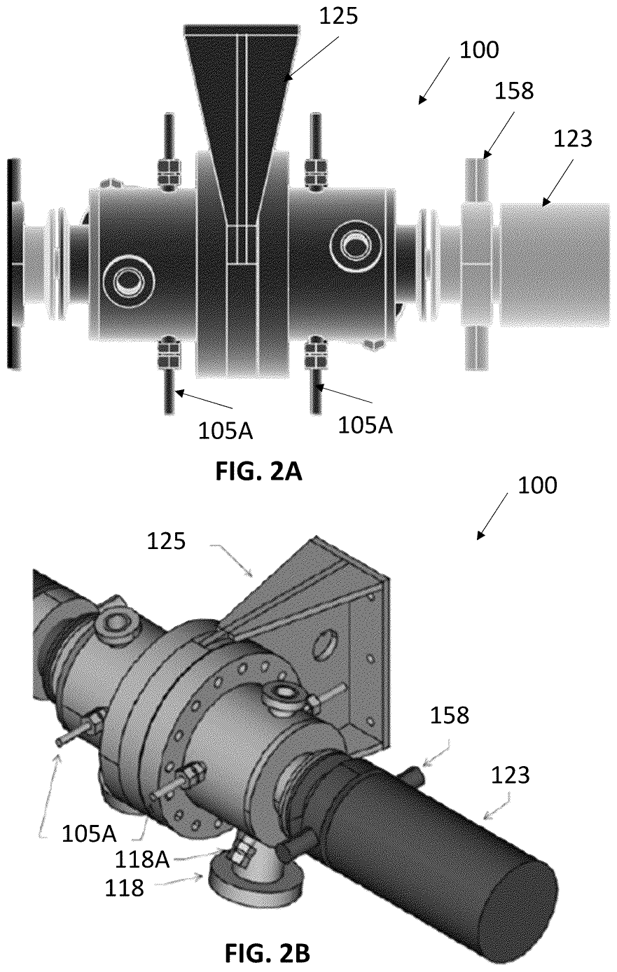

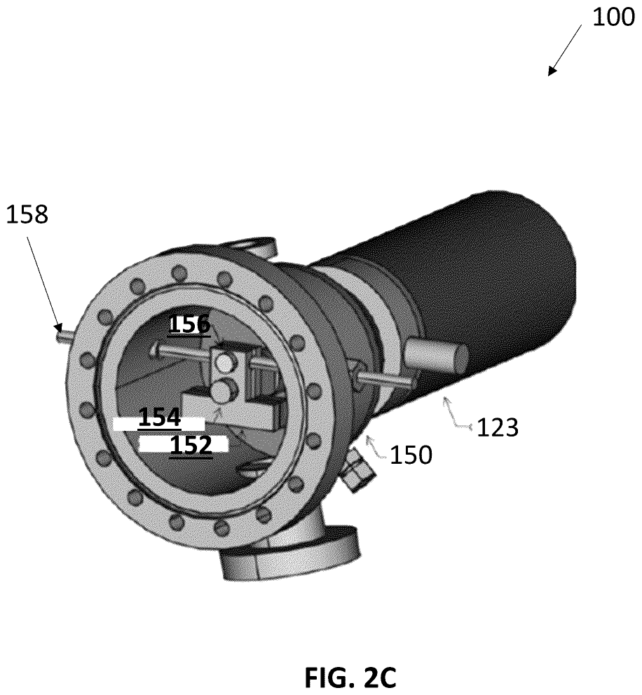

In some embodiments, each of the cold traps may include a vacuum chamber and a cold head (e.g., a T-shaped cold head) positioned within the vacuum chamber. As an example, FIG. 2C shows an interior of a cold trap (e.g., the cold trap 122 or the cold trap 124) of the purification system 123. As shown in FIG. 2C, the cold trap includes a trap housing 150, which defines at least a portion of the vacuum chamber. A cold head 152 is positioned within the trap housing 150 and mounted by a mounting screw 154. The tubing 158 may have a diameter (e.g., 0.25 inches, etc.) that matches the tubing of the mass spectrometer 105. The tubing 158 may deliver gas to and/or from the cold trap.

During purification of the gas residing within the cold trap, the tubing 158 is cooled via the cold head 152. This reduces a temperature of a gas residing within the cold trap to a threshold temperature at which the non-target portion of the gas condenses. In some embodiments, the threshold temperature is approximately 33K to 34K, 20K to 30K, 30K to 40K, 40K to 50K, 50K to 60K, 60K to 70K, or other ranges therebetween. In some embodiments, the threshold temperature may be specifically selected to minimize sensitivity of the mass spectrometer 105 ion beam to temperature fluctuations in the cold trap. Reducing the temperature during purification freezes or condenses the non-target portion of the gas, such as oxygen, argon, and other condensable trace elements or contaminants within the gas being purified. As described herein, this effectively increases the concentration of the target portion supplied to the mass spectrometer 105 by several orders of magnitude. While it is noted that the target portion can be isolated or have increased concentration as a result of the purification, in some embodiments, residual (though minimal) amounts of the remaining non-target portion of the gases may be delivered to the mass spectrometer 105 with the target portion. The cold trap may also include a resistance temperature detector 156 that measures a temperature within the cold trap to ensure that the temperature within the cold trap is lowered to a predetermined threshold during purification and/or raised to a predetermined threshold during regeneration.

The cold trap may additionally and/or alternatively include a heater (not shown) to heat the remaining portion (e.g., non-target portion) of the gas during regeneration. The heater may include a polyimide coated resistance heater among other heaters. The heater may be coupled to and/or positioned within the cold head 152. The cold trap is regenerated by increasing the temperature within the cold trap (e.g., via control of the heater by the controller 110) to a temperature threshold (e.g., approximately 300K or the like) and pumping away the trapped gases (e.g., via the vacuum port 118 shown in FIG. 1) while gas is flowing to the mass spectrometer 105 through the other cold trap. To avoid degradation of the cold trap housing 150 during heating, the controller 110 may operate at least one of the valves to at least temporarily isolate each trap housing. During heating, the controller 110 causes power to be supplied to the heater, while the cryocooler is turned off. The complete heating and cooldown sequence may take approximately 25 minutes (or another predetermined time range) and may be fully or partially automated (e.g., and controlled by the controller 110).

FIGS. 2A and 2B illustrate additional views of at least a portion of the mass spectrometer system 100, consistent with implementations of the current subject matter. As shown in FIGS. 2A and 2B, the purification system 123 may be mounted via a mount 125. The purification system 123 may be coupled to the mass spectrometer 105 via tubing 105A. As described above, the cryocooler 123 may be used to purify the gases contained within the cold traps. Further, gas may be vented, such as during regeneration, from the cold traps via a vent port 118A, which can be coupled to the vacuum port 118.

Referring back to FIG. 1, the controller 110 may modulate the second valve 128. As noted, the second valve 128 may include a COV valve, two-way valve, a three-way valve, a pneumatic valve, a shut-off valve, an adjustable-flow valve, or other configuration. The second valve 128 may modulated to stabilize a pressure of the sample gas and the reference gas during operation of the purification system 123 and to alternate delivery of the purified sample gas and the purified reference gas under constant flow to the mass spectrometer 105 from the corresponding cold trap.

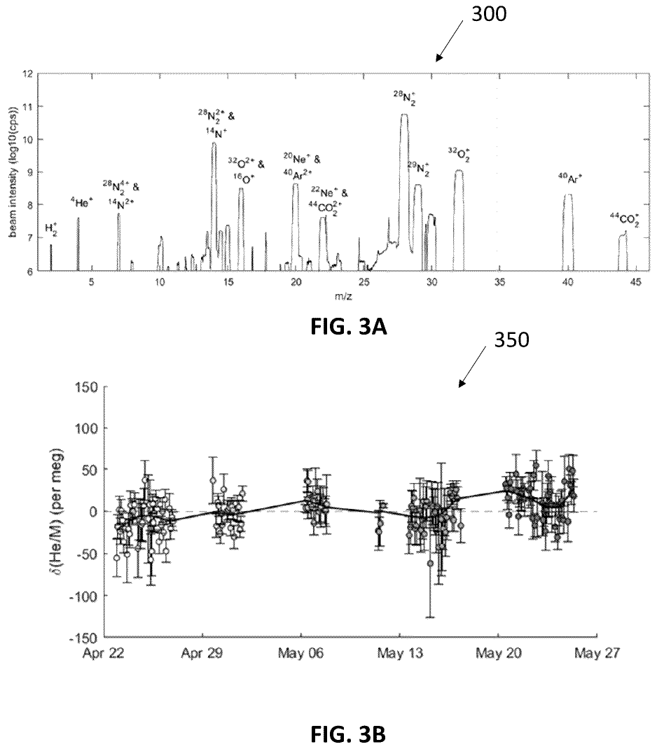

FIGS. 3A and 3B illustrate graphs depicting the performance of the mass spectrometer system 100, consistent with implementations of the current subject matter. For example, FIG. 3A depicts a graph 300 showing the concentration of elements (e.g., gases) within a gas mixture after purification by the purification system 123 that is delivered to the mass spectrometer 105. While in this test, there were residual amounts of non-target gases, such as nitrogen, the graph 300 shows that the target portion (e.g., helium, nitrogen, and hydrogen) relative to air was greatly enriched. Although the measured 4He+beam was 1450 times smaller than the ²⁸N₂+ beam due to the residual vapor pressure of N₂ at approximately 33K, the He/N₂ ratio was estimated to increase 1000- to 1500-fold, taking into account the approximately 10 times lower ionization efficiency of He. The ratios of O₂/N₂ and Ar/N₂ were also considerably lower in the gas mixture reaching the mass spectrometer 105 than in non-purified air because Ar, O₂, and CO₂ are more readily frozen out of the gas stream than N₂ during purification.

FIG. 3B depicts a graph 350 showing repeat measurements of the same sample and reference gas that were used in generating the graph 300, consistent with implementations of the current subject matter. As shown in the graph 350, the repeat measurements of the same sample and reference gas combination using the mass spectrometer system 100 show only a small amount of drift and overall good reproducibility over a period of five weeks. During this testing, the sample and reference gases were alternated every six seconds, following a four second waiting period after each switch between the reference and sample gas. The sample gas was delivered from the same air standard for all measurements which typically lasted about twenty minutes.

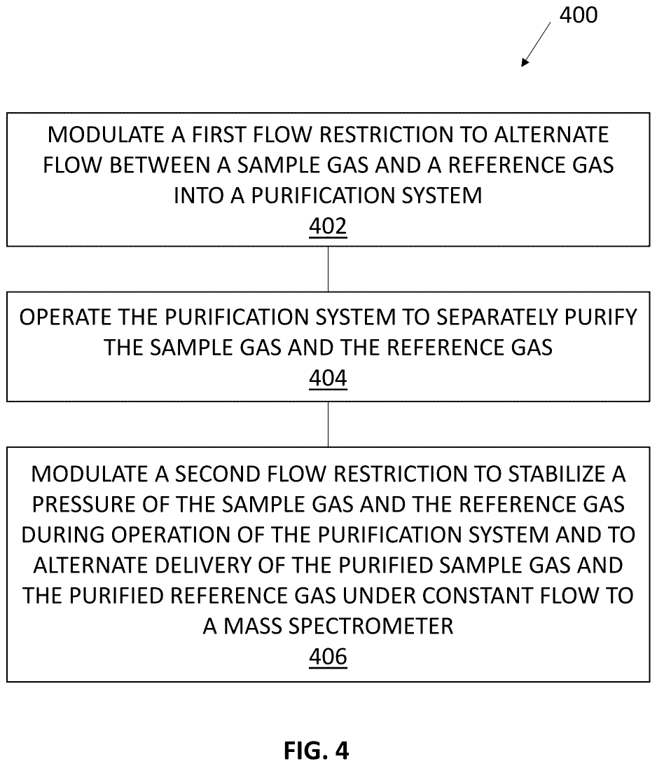

FIG. 4 depicts a flowchart illustrating a process 400 for improving the precision of a mass spectrometer in analyzing a gas, consistent with implementations of the current subject matter. The process 400 may be implemented by the control system 102, such as via the controller 110 and/or the data acquisition device 108. The process 400 may be used with the mass spectrometer system 100 shown in FIGS. 1-3, and may be used to control purification of gases under constant flow and monitoring prior to delivery of the gases to a mass spectrometer described herein.

At 402, the controller 110 may modulate a first valve to alternate flow between a sample gas and a reference gas into a purification system (e.g., the purification system 123). In some embodiments, the controller is configured to modulate at least the first valve to cause the sample gas or the reference gas to flow to the purification system (e.g., a first cold trap or a second cold trap of the purification system as described herein).

In some embodiments, the sample gas is a first mixture and the reference gas is a second mixture. The first mixture and the second mixture may each include a gas. Purification of the sample gas and the reference gas may isolate a target portion (e.g., one or more elements) of the first mixture and the second mixture for analysis by a mass spectrometer.

In some embodiments, the first valve includes at least one valve. The at least one valve may include a COV valve, a trap selector valve, a flow control valve, a shut-off valve, a three-way valve, and/or the like. The controller 110 may modulate at least the first valve to maintain constant flow of the sample gas and the reference gas to the mass spectrometer.

At 404, the controller 110 may operate the purification system to separately purify the sample gas and the reference gas. In some embodiments, the controller 110 operates the purification system to purify the sample gas and the reference gas by at least isolating a target portion of the sample gas and the reference gas for analysis by the mass spectrometer. The purification system may be operated such that the sample gas and the reference gas are alternatively purified. In other words, the controller 110 operates the purification system to purify either the reference gas or the sample gas at a time and the reference gas and the sample gas are not purified concurrently. Additionally and/or alternatively, the controller 110 operates the purification system to purify the reference gas and the sample gas in parallel.

In some embodiments, the controller 110 further purifies the sample gas and the reference gas by at least purging a remaining portion of the sample gas and the reference gas from the purification system prior to causing delivery of the sample gas or the reference gas to the mass spectrometer. The remaining portion of the sample gas and the reference gas may include other elements of the gas that are not needed for the analysis by the mass spectrometer. In some instances, the remaining portion of the sample gas and the reference gas includes condensable trace gases that are removed from the sample gas and the reference gas prior to delivering the target portion to the mass spectrometer.

The purification system may be a cryogenic gas purification system configured to cryogenically purify the sample gas and the reference gas. The cryogenic gas purification system cools or otherwise freezes the remaining portion of the sample gas and the reference gas to isolate the target portion of the sample gas and the reference gas. In some embodiments, the target portion includes at least one of helium, nitrogen, and neon. Such gases may be the focus of the analysis by the mass spectrometer. These gases may not be filtered by the purification system. For example, in some embodiments, these gases may not freeze or otherwise solidify when cooled by the purification system.

The purification system may include a first cold trap and a second cold trap. In the first cold trap, either the sample gas or the reference gas may be purified by at least reducing a temperature of the gas mixture (either the sample gas or the reference gas that is currently contained within the first cold trap) to isolate the target portion of the gas. Concurrently, the second cold trap may be regenerated to remove a remaining portion of the other gas mixture (e.g., the other one of the sample gas or the reference gas). The remaining portion of the gas within the second cold trap is the portion of the gas (either the sample gas or the reference gas) that remained within the second cold trap after purification of the gas within the second cold trap. The controller 110 may cause a heater of either cold trap (the first or second cold trap) to regenerate the cold trap to remove the remaining portion of the gas by at least heating the remaining portion of the gas within the cold trap.

The controller 110 can alternate purifying the sample gas and the reference gas across the first and second cold traps. While one cold trap is purifying a gas (e.g., the sample or the reference gas), the other cold trap may be regenerated to remove the remaining portion of the gas most recently purified within that cold trap, purging the remaining portion of the gas. Thus, the first cold trap and the second cold trap allow for the controller 110 to continuously purify and monitor the sample gas and/or the reference gas within the purification system.

At 406, the controller 110 may modulate a second valve to stabilize a pressure of the sample gas and the reference gas during operation of the purification system and to alternate delivery of the purified sample gas and the purified reference gas under constant flow to a mass spectrometer (e.g., the mass spectrometer 105).

In some embodiments, the second valve includes at least one valve. The at least one valve may include a flow control valve, a shut-off valve, a three-way valve, and/or the like. The controller 110 may modulate at least the second valve to maintain constant flow of the sample gas and the reference gas to the mass spectrometer.

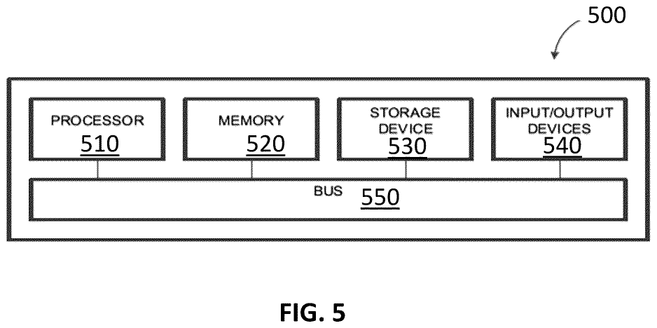

FIG. 5 depicts a block diagram illustrating a computing system 500 consistent with implementations of the current subject matter. Referring to FIGS. 1-4, the computing system 500 can be used to implement the mass spectrometer system 100, such as the purification system 123, the control system 102, the mass spectrometer 105, and/or any components therein.

As shown in FIG. 5, the computing system 500 can include a processor 510, a memory 520, a storage device 530, and input/output device 540. The processor 510, the memory 520, the storage device 530, and the input/output device 540 can be interconnected via a system bus 550. The processor 510 is capable of processing instructions for execution within the computing system 500. Such executed instructions can implement one or more components of, for example, the control system 102, the purification system 123, and/or the mass spectrometer 105. In some example implementations, the processor 510 can be a single-threaded processor. Alternatively, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, a tape device, a solid-state device, and/or any other suitable persistent storage means. The input/output device 540 provides input/output operations for the computing system 500. In some example implementations, the input/output device 540 includes a keyboard and/or pointing device. In various implementations, the input/output device 540 includes a display unit for displaying graphical user interfaces.

According to some example implementations, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some example implementations, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C,” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A system comprising:
a purification system configured to cryogenically purify a sample gas and a reference gas for analysis by a mass spectrometer; and
a control system coupled to the purification system, wherein the control system comprises a controller configured to:
modulate a first valve to alternate flow between the sample gas and the reference gas into the purification system;
operate the purification system to separately cryogenically purify the sample gas and the reference gas; and
modulate a second valve to stabilize a pressure of the sample gas and the reference gas during operation of the purification system and to alternate delivery of the purified sample gas and the purified reference gas under constant flow to the mass spectrometer.

2. The system of claim 1, wherein the controller is configured to operate the purification system to purify the sample gas and the reference gas by at least isolating a target portion of the sample gas and the reference gas for analysis by the mass spectrometer; and purging a remaining portion of the sample gas and the reference gas.

3. The system of claim 2, wherein the target portion includes at least one of helium, nitrogen, and neon.

4. The system of claim 1, wherein the purification system comprises:
a first cold trap in which the sample gas is configured to be purified by at least reducing a temperature of the sample gas to isolate a target portion of the sample gas; and
a second cold trap configured to be regenerated for removal of a remaining portion of the reference gas from the second cold trap while the sample gas is purified within the first cold trap, wherein the remaining portion of the reference gas remained within second cold trap after purification of the reference gas within the second cold trap,
wherein the first cold trap and the second cold trap allows for continuous purification and monitoring of the sample gas and/or the reference gas within the purification system.

5. The system of claim 4, wherein the controller is configured to modulate at least the first valve to cause flow of the sample gas or the reference gas to the first cold trap or the second cold trap.

6. The system of claim 4, wherein the controller is configured to continuously monitor the sample gas and/or the reference gas within the first cold trap and the second cold trap.

7. The system of claim 4, wherein the second cold trap comprises a heater, and wherein the controller is configured to operate the heater to regenerate the second cold trap for removal of the remaining portion of the reference gas by at least heating the remaining portion.

8. The system of claim 1, wherein the sample gas is a first mixture; and the reference gas is a second mixture; and wherein purification of the sample gas and the reference gas isolates a target portion of the first mixture and the second mixture for analysis by the mass spectrometer.

9. The system of claim 1, wherein the first valve comprises at least one valve; and wherein the second valve comprises at least one valve.

10. The system of claim 1, wherein the controller is configured to module the first valve and the second valve to maintain the constant flow of the sample gas and the reference gas to the mass spectrometer.

11. A method comprising:
modulating a first valve to alternate flow between the sample gas and the reference gas into a purification system configured to cryogenically purify a sample gas and a reference gas for analysis by a mass spectrometer;
operating the purification system to separately cryogenically purify the sample gas and the reference gas; and
modulating a second valve to stabilize a pressure of the sample gas and the reference gas during operation of the purification system and to alternate delivery of the purified sample gas and the purified reference gas under constant flow to the mass spectrometer.

12. The method of claim 11, wherein the operating includes isolating a target portion of the sample gas and the reference gas for analysis by the mass spectrometer; and purging a remaining portion of the sample gas and the reference gas.

13. The method of claim 12, wherein the target portion includes at least one of helium, nitrogen, and neon.

14. The method of claim 11, wherein the purification system comprises:
a first cold trap in which the sample gas is configured to be purified by at least reducing a temperature of the sample gas to isolate a target portion of the sample gas; and
a second cold trap configured to be regenerated for removal of a remaining portion of the reference gas while the sample gas is purified within the first cold trap, wherein the remaining portion of the reference gas remained within second cold trap after purification of the reference gas within the second cold trap,
wherein the first cold trap and the second cold trap allows for continuous purification and monitoring of the sample gas and/or the reference gas within the purification system.

15. The method of claim 14, further comprising modulating at least the first valve to cause flow of the sample gas or the reference gas to the first cold trap or the second cold trap.

16. The method of claim 14, further comprising continuously monitor the sample gas and/or the reference gas within the first cold trap and the second cold trap.

17. The method of claim 14, wherein the second cold trap comprises a heater, and wherein the method further comprises operating the heater to regenerate the second cold trap for removal of the remaining portion of the reference gas by at least heating the remaining portion.

18. The method of claim 1, wherein the sample gas is a first mixture; and the reference gas is a second mixture; and wherein purification of the sample gas and the reference gas isolates a target portion of the first mixture and the second mixture for analysis by the mass spectrometer.

19. The method of claim 1, wherein the first valve comprises at least one valve; and wherein the second valve comprises at least one valve.

20. The method of claim 1, further comprising modulating the first valve and the second valve to maintain the constant flow of the sample gas and the reference gas to the mass spectrometer.

21. (canceled)
